(19) United States
(12) Patent Application Publication
(10) Pub. No.: US 2016/0234292 A1
(43) Pub. Date: Aug. 11, 2016

(54) SERVER AND METHOD FOR TRANSMITTING DATA

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YOUNG-WAY LIU, New Taipei (TW); CHIH-SAN CHIANG, New Taipei (TW); HAI-JUN MAO, Shenzhen (CN); HAI-SEN LIANG, Shenzhen (CN)

(21) Appl. No.: 14/820,200

(22) Filed: Aug. 6, 2015

(30) Foreign Application Priority Data
Feb. 9, 2015 (CN) 201510065942.2

(51) Int. Cl. H04L 29/08

(52) U.S. Cl. CPC H04L 67/06; H04L 67/34

(57) ABSTRACT

A server and data transmission method are provided. Programs need at least one processor for receiving a request from a terminal device, the request including information of data and identity information of a device for receiving the data; and obtain the data corresponding to the information included in the request. The method transmits the data to the device corresponding to the identity information included in the request.

### CROSS-REFERENCE TO RELATED APPLICATIONS

This application claims priority to Chinese Patent Application No. 201510065942.2 filed on Feb. 9, 2015, the contents of which are incorporated by reference herein.

### FIELD

The subject matter herein generally relates to data transmission.

### BACKGROUND

A server can receive a request for downloading data from a terminal device. The server downloads the data and sends the data to the terminal device in response to the request.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a server applying a data transmission system.

FIG. 2 is a flowchart of an embodiment of a data transmission method for a server, such as the one of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

The present disclosure is described in relation to a server and data transmission method. Programs need at least one processor for receiving a request from a terminal device, the request comprising information of data and identity information of a device for receiving the data; and obtain the data corresponding to the information included in the request. The method transmits the data to the device corresponding to the identity information included in the request.

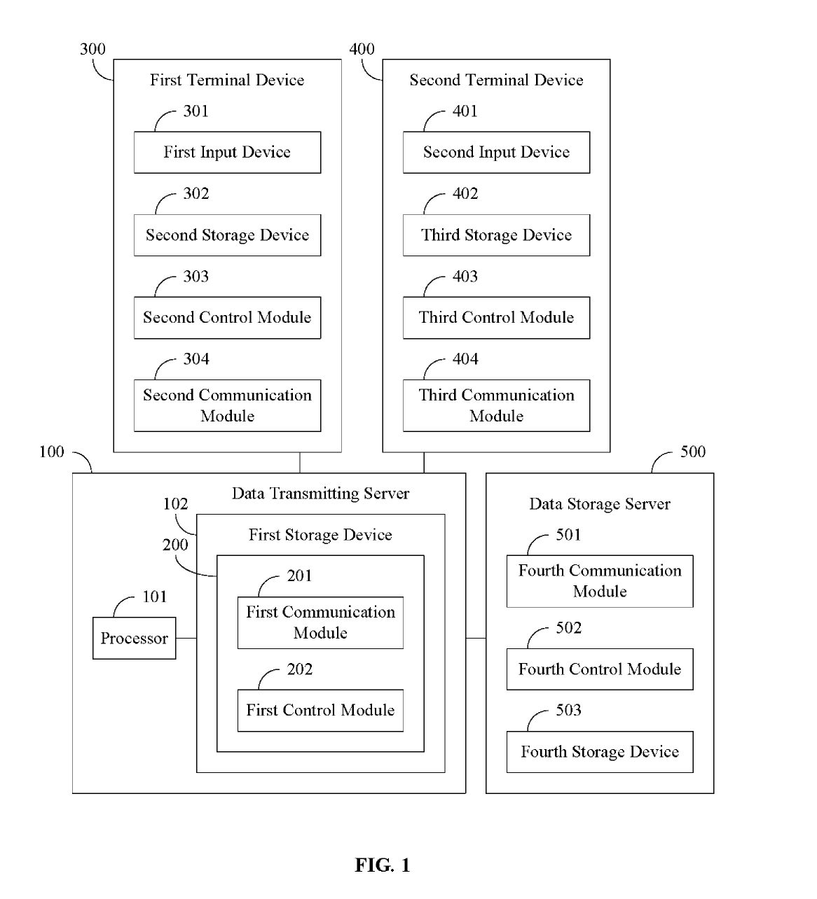

FIG. 1 illustrates an embodiment of a data transmission server 100. A data transmission system 200 is applied to the data transmission server 100. The data transmission server 100 can include at least one processor 101 and a first storage device 102. In at least one embodiment, the data transmission server 100 includes one processor 101. The processor executes instructions of a number of modules stored in the first storage device 102. The first storage device 102 can store a first communication module 201 and a first control module 202.

The data transmission server 100 can be coupled to a first terminal device 300, a second terminal device 400 and a data storage server 500. The first terminal device 300 can include a first input device 301, a second storage device 302, a second control module 303 and a second communication module 304. The first input device 301 generates an input signal corresponding to an input operation of a user. The second control module 303 then generates a request for transmitting data corresponding to the input signal, and the second communication module 304 sends the request to the data transmission server 100. In at least one embodiment, the request can be a download request or an upload request. The download request includes information of data to be downloaded and identity information of a device for receiving the downloaded data. The upload request includes information of data to be uploaded, the data to be uploaded and identity information of a device for receiving the uploaded data.

The second terminal device 400 can include a second input device 401, a third storage device 402, a third control module 403 and a third communication module 404. A user can operate the second input device 401 to generate an input signal. Then the third control module 403 generates a request for transmitting data and the third communication module 404 sends the request to the data transmission server 100.

The first communication module 201 receives the request from the first terminal device 300 or the second terminal device 400 and the first control module 202 obtains the data to be transmitted. If the request is the download request, the first control module 202 generates a control signal corresponding to the download request, and the first communication module 201 sends the control signal to the data storage server 500. In at least one embodiment, the control signal includes the information of data to be downloaded. If the request is the upload request, the first control module 202 receives the data to be uploaded and the first storage device 102 stores the data to be uploaded.

The data storage server 500 can include a fourth communication module 501, a fourth control module 502 and a fourth storage device 503. The fourth communication module 501 receives the control signal. In response to the control signal, the fourth control module 502 downloads data corresponding to the information included in the control signal from the fourth storage device 503. Then the fourth communication module 501 sends the downloaded data to the data transmission server 100. The first communication module 201 receives the downloaded data and the first storage device 102 stores the downloaded data.

The first control module 202 controls the first communication module 201 to send the data to be transmitted to the device corresponding to the identity information included in the request. If the request is the download request, the first control module 202 controls the first communication module 201 to send the downloaded data to the device corresponding to the identity information included in the download request, such as the first terminal device 300 or the second terminal device 400. If the request is the upload request, the first control module 202 controls the first communication module 201 to send the uploaded data to the device corresponding to the identity information included in the upload request, such as the second terminal device 400 or the data storage server 500.

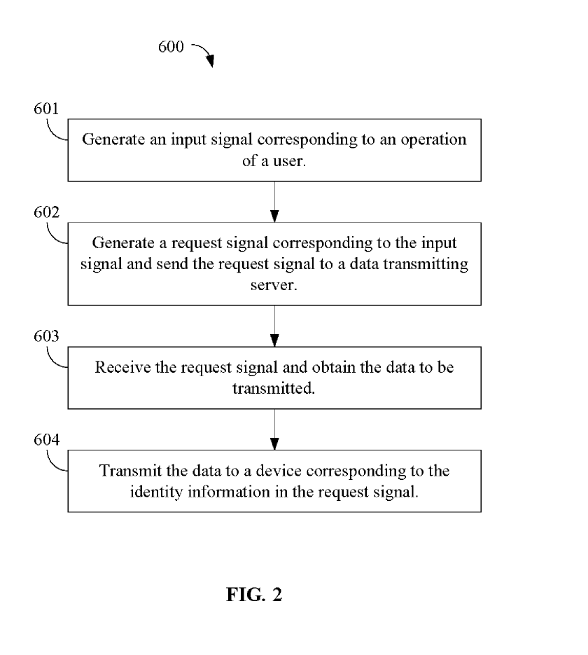

Referring to FIG. 2, a flowchart is presented in accordance with an example embodiment. A method 600 is provided by way of example, as there are varieties of ways to carry out the method. The method 600 described below can be carried out using the configurations illustrated in FIG. 1 and various elements of these figures are referenced in explaining example method 600. Each block shown in FIG. 2 represents one or more processes, methods, or subroutines, carried out in the exemplary method 600. Furthermore, the illustrated order of blocks is by example only and the order of the blocks can be changed. Additional blocks may be added or fewer blocks may be utilized, without departing from this disclosure. The exemplary method 600 can begin at block 601.

At block 601, a first input device of a first terminal device generates an input signal corresponding to an operation of a user.

At block 602, a second control module generates a request corresponding to the input signal and a second communication module sends the request to a data transmission server. The request includes information to be transmitted and identity information of a device for receiving the transmitted data. In at least one embodiment, the request can be a download request or an upload request. The download request includes information of data to be downloaded and identity information of a device for receiving the downloaded data, and the upload request includes information of data to be uploaded, the data to be uploaded and identity information of a device for receiving the uploaded data.

At block 603, a first communication module of the data transmission server receives the request and a first control module obtains the data to be transmitted. In at least one embodiment, if the request is the download request, the first control module generates a control signal corresponding to the download request and the first communication module sends the control signal to a data storage server to control the data storage server to download the data and to send the data to the data transmission server. If the request is the upload request, the first communication module receives the data and the first storage device stores the data.

At block 604, the first control module controls the first communication module to transmit the data to the device corresponding to the identity information included in the request. In at least one embodiment, if the request is the download request, the first control module controls the first communication module to send the downloaded data to the device corresponding to the identity information included in the download request, such as the first terminal device or a second terminal device. If the request is the upload request, the first control module controls the first communication module to send the uploaded data to the device corresponding to the identity information included in the upload request, such as the data storage server or the second terminal device.

The embodiments shown and described above are only examples. Many details are often found in the art such as the other features of a server and method for transmitting data. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A server comprising:
at least one processor;
a non-transitory storage device coupled to the at least one processor and storing one or more programs, which when executed by the at least one processor, cause the at least one processor to:
receive a request from a terminal device, the request comprising information of data and identity information of a device, different from the terminal device, for receiving the data;
obtain the data corresponding to the information comprised in the request; and
transmit the data to the device corresponding to the identity information comprised in the request.

2. The server of claim 1, wherein the request is a download request which comprises information of data to be downloaded and identity information of a device for receiving the data, the one or more programs cause the at least one processor to further:
generate a control signal in response to the download request;
send the control signal to a data storage server storing the data corresponding to the information comprised in the download request;
receive the data from the data storage server; and
send the data to the device corresponding to the identity information comprised in the download request.

3. The server of claim 1, wherein the request is an upload request which comprises information of data to be uploaded, the data and identity information of a device for receiving the data, the one or more programs cause the at least one processor to further:
receive the data comprised in the upload request; and
send the data to the device corresponding to the identity information comprised in the download request.

4. The server of claim 3, wherein the device corresponding to the identity information is the data storage server and/or other terminal devices.

5. A computer-based method for transmitting data for a server being executed by at least one processor of the electronic device, the method comprising:
receiving a request from a terminal device, the request comprising information of data and identity information of a device, different from the terminal device, for receiving the data;
obtaining the data corresponding to the information comprised in the request; and
transmitting the data to the device corresponding to the identity information comprised in the request.

6. The method of claim 5, wherein the request is a download request which comprises information of data to be downloaded and identity information of a device for receiving the data, the method further comprising:
generating a control signal in response to the download request;
sending the control signal to a data storage server storing the data corresponding to the information comprised in the download request;
receiving the data from the data storage server; and
sending the data to the device corresponding to the identity information comprised in the download request.

7. The method of claim 5, wherein the request is an upload request which comprising information of data to be uploaded, the data and identity information of a device for receiving the data, the method further comprising:
receiving the data comprised in the upload request; and
sending the data to the device corresponding to the identity information comprised in the download request.

8. The method of claim 7, wherein the device corresponding to the identity information is the data storage server and/or other terminal devices.

9. A non-transitory storage device having stored thereon instructions that, when executed by a processor of a server, causes the processor to perform a data transmission method, the method comprising:
receiving a request from a terminal device, the request comprising information of data and identity information of a device, different from the terminal device, for receiving the data;
obtaining the data corresponding to the information comprised in the request; and
transmitting the data to the device corresponding to the identity information comprised in the request.

10. The method of claim 9, wherein the request is a download request which comprises information of data to be downloaded and identity information of a device for receiving the data, the method further comprising:
generating a control signal in response to the download request;
sending the control signal to a data storage server storing the data corresponding to the information comprised in the download request;
receiving the data from the data storage server; and
sending the data to the device corresponding to the identity information comprised in the download request.

11. The method of claim 9, wherein the request is an upload request which comprises information of data to be uploaded, the data and identity information of a device for receiving the data, the method further comprising:
receiving the data comprised in the upload request; and
sending the data to the device corresponding to the identity information comprised in the download request.

12. The method of claim 11, wherein the device corresponding to the identity information is the data storage server and/or other terminal device.
